(19) United States
(12) Patent Application Publication
(10) Pub. No.: US 2011/0078852 A1
(43) Pub. Date: Apr. 7, 2011

(54) METHOD AND APPARATUS FOR SEALING POOL FIXTURES TO VINYL POOL LINERS

(75) Inventors: Michael Gibson, Atlanta, GA (US); Robert G. Dickie, King City (CA)

(73) Assignee: ASSOCIATED LEISURE PRODUCTS, INC., Norcross, GA (US)

(21) Appl. No.: 12/572,749

(22) Filed: Oct. 2, 2009

(51) Int. Cl. E04H 4/00; B23P 17/04

(52) U.S. Cl. 4/506; 29/428

(57) ABSTRACT

A sealing member for sealing a pool fixture to a vinyl pool liner and a method of using the same. The sealing member includes inner and outer frame members, one of which includes a channel and the other includes a projection complementary to the channel. A bead of sealing material is provided one of in the channel and on the projection. When the inner and outer frame members are engaged with each other, the projection is received in the channel and a portion of the pool liner retained thereinbetween is maintained in contact with the sealing material.

### BACKGROUND OF THE INVENTION

1. Technical Field

This invention generally relates to pool equipment and installation of the same. More particularly, the invention relates to a device for securing a pool fixture and pool liner together. Specifically, the invention relates to a sealing member that retains the pool liner between an inner and outer frame member in such a manner that the liner is not pierced.

2. Background Information

There are many in-ground swimming pools sold and used in North American that use a vinyl liner type of construction approach versus a traditional concrete molded system. The vinyl liners in these pools are typically in the range of 0.017 ″ to 0.03″ thick and generally have to be changed after around ten years of use. Additionally, a variety of plastic or fiberglass fixtures such as stairs, skimmers, underwater lights, speakers, drains and filling ports have to be installed and sealed to the new vinyl liner once it has been installed in the pool.

Installing a new liner is a time-consuming task that must be undertaken with care in order not to puncture the liner. The first step involves removal of the old liner, followed by cleanup and repair of the surface that is to support the new liner. If the pool includes plastic stairs, the installer must construct a bridge across the top of the stairs. The new liner is then placed on the bottom of the pool and the outer perimeter of the liner is systematically zipped into a specially designed track mounted around the uppermost lip of the pool. During this process, the liner is drawn up against the bridge across the stairs so that a portion of the liner spans the opening to the stairs. A vacuum hose is positioned between the liner and the sidewall of the pool in order to evacuate the air between the liner and the surface supporting the same. This process also aids in smoothing out any wrinkles in the liner. The installer then starts filling the pool with water and stops when the water reaches a depth of about six inches in the shallow end.

At this point, the installer needs to install the various pool fixtures and provide access to the stairs, if present. This is accomplished by installing an outer frame member and a rubber gasket in the appropriate regions of the pool to seal the liner surrounding the fixture or the stairs. The outer frame member and gasket are designed to be engaged with the fixture and are shaped appropriately. Each of the gasket and outer frame member are provided with pre-drilled or pre-formed apertures therein for the insertion of fasteners into aligned apertures in the fixture. The gasket is positioned in abutting contact with the exterior surface of that portion of the liner disposed over the apertures in the fixture. The outer frame member is positioned in abutting contact with the gasket and then a number of fasteners are inserted through the aligned apertures in the outer frame member, the gasket and the fixture. This, of course, results in perforation of the liner at each and every location that a fastener is used. A typical stair system, for example, may require as many as eighty 1½″ screws to secure the liner around the stairs. The screws typically are positioned every three to four inches along the length of the face place. When all of the screws are tightly fixed into place, the outer frame member essentially retains the liner and gasket to the fixture and thereby seals off the liner around the same. The installer then cuts away that portion of the liner that is blocking access to the fixture.

This method of installation is problematic for a number of reasons. Firstly, it is a very time consuming and labor intensive because the installer has to physically install each and every fastener. This can be quite difficult as it may require the installer to lie on their stomach and reach downwardly into the pool to screw in each and every fastener from an awkward angle. This time consuming and labor intensive activity forms part of the cost of installation of the liner. Consequently, the longer it takes to accomplish this task, the more it bites into the profit for the job. Secondly, since this installation method involves repeated puncturing of the liner, this type of installation may lead to leaking problems if the installer is less skilled.

There is therefore a need in the art for an improved method and apparatus for securing and sealing a vinyl pool liner to a pool fixture.

### SUMMARY OF THE INVENTION

The present invention is a device used to seal a pool fixture and a vinyl pool liner together and a method of using the same. The sealing member includes an inner frame member which is mounted on the pool fixture or is integrally molded as part of the fixture. The outer frame is designed to interlockingly engage the inner frame member retaining the pool liner between the inner and outer frames. One of the inner and outer frame members includes a channel and the other includes a complementary projection that is receivable in the channel. A bead of sealing material is provided one of in the channel and on the projection. When the inner and outer frame members are engaged, the liner is pushed into the channel by the projection and is maintained in contact with the sealing material. The outer frame member is easily removed from the inner frame member to allow for periodic replacement of the pool liner.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a first embodiment of a sealing member in accordance with the present invention, showing the inner and outer frame members thereof interlocking engaged with each other;

FIG. 2 is a cross-sectional view of the device of FIG. 1;

FIG. 3 is a perspective view of a stair system for installation in a pool and showing the device of the present invention exploded away from the stair system to reveal the sealing strips of the present invention;

FIG. 4 is an exploded cross-sectional view of the sealing strips in accordance with the present invention;

FIG. 5 is a partial exploded cross-sectional view of the xxx

FIG. 6 is a cross-sectional view of the vinyl liner stalled on the stair utilizing the sealing strips of the present invention;

FIG. 7 is a perspective view of the stair system showing the sealing strips and pool liner fully engaged therewith;

FIG. 8 is a cross-sectional view of the vinyl liner being sealed to the stair system, wherein the sealing strip is not yet engaged with the vinyl liner;

FIG. 9 is a cross-sectional view of the sealing strip initially contacting the vinyl liner;

FIG. 10 is a cross-sectional view of the sealing strip being forced into locking engagement with the base;

FIG. 11 is a cross-sectional view of the sealing strip completely locking the vinyl liner to the stair system and completely sealing the same;

FIG. 12 shows a cross-sectional view of a second embodiment of a sealing strip in accordance with the present invention being engaged with a stair system; and where the sealing strip includes a lock for preventing accidental disengagement of the sealing strip from the stair system;

FIG. 13 is a cross-sectional view of the stair system of FIG. 12 and showing the sealing strip initially contacting the vinyl liner;

FIG. 14 is a cross-sectional view of the stair system of FIG. 13 where the lock member is beginning to enter the mating aperture;

FIG. 15 is a cross-sectional view of the stair system of FIG. 14 where the lock member is fully received in the mating aperture;

FIG. 16 is a perspective view of a pool fixture incorporating a third embodiment of a sealing system in accordance with the present invention; where the sealing system is a frame type of system;

FIG. 17 is a side view of the fixture of FIG. 16;

FIG. 18 is an exploded perspective view of the fixture of FIG. 16;

FIG. 19 is a front view of the fixture of FIG. 16;

FIG. 20 is a cross-sectional view taken through line B-B of FIG. 19; and

FIG. 21 is an enlarged cross-sectional view of the circled highlighted area of FIG. 20.

### DETAILED DESCRIPTION OF THE INVENTION

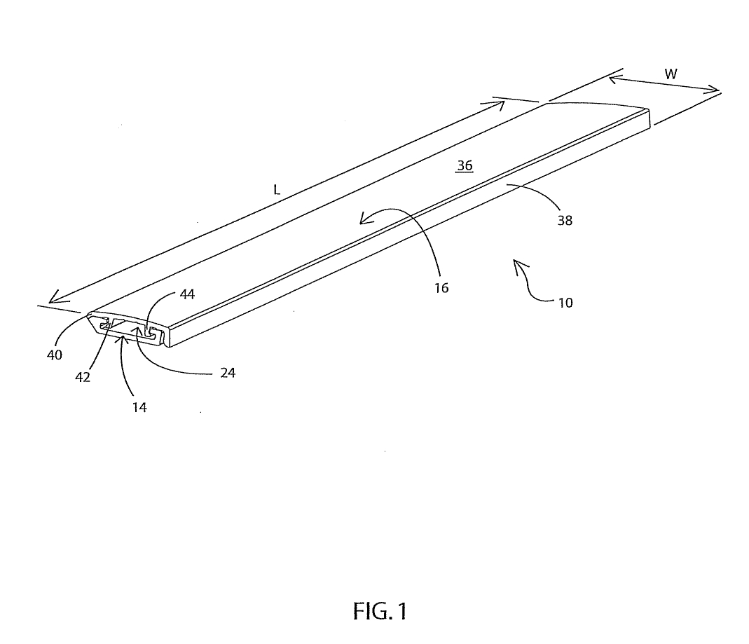

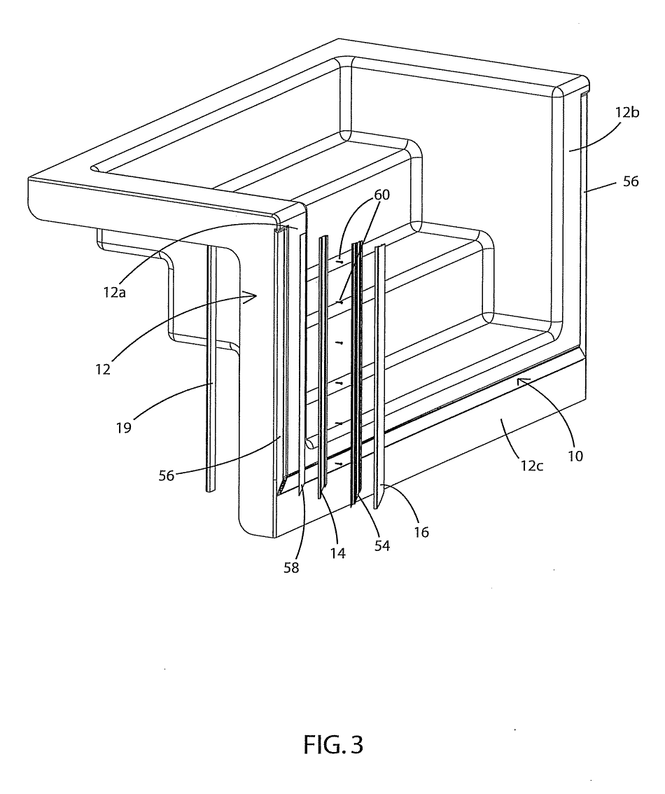

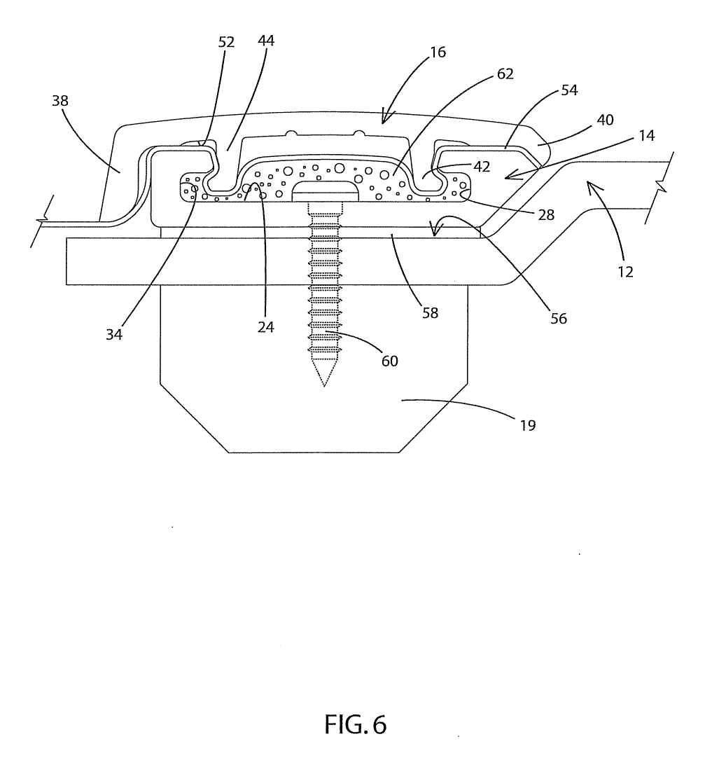

Referring to FIGS. 1-7, there is shown a first embodiment of a sealing member for securing vinyl pool liners to pool fixtures in accordance with the present invention and generally indicated at 10. In particular, this embodiment of the sealing member 10 is designed for use with larger pool fixtures such as stair systems 12 (FIG. 3).

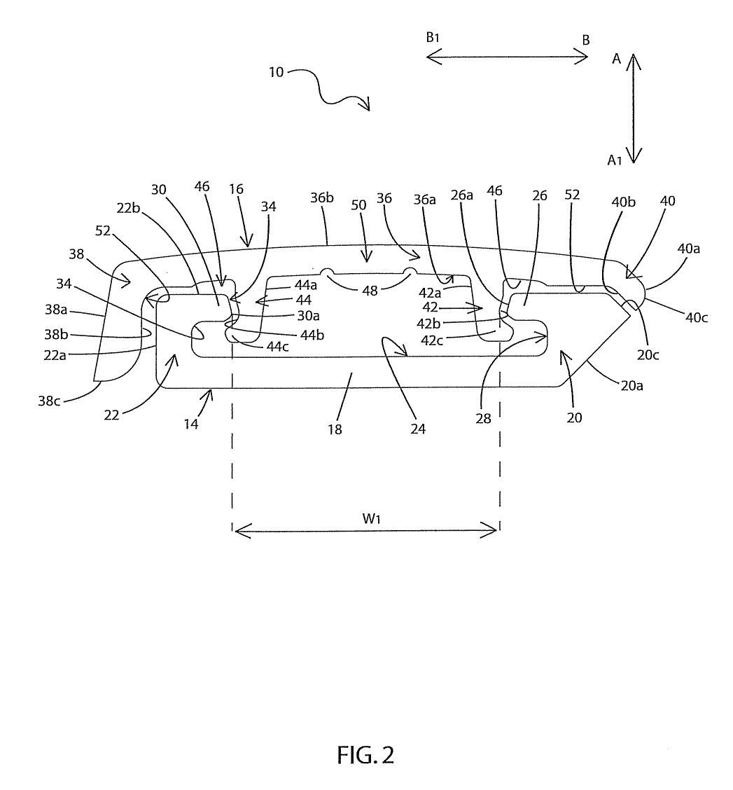

Sealing member 10 comprises an inner frame member 14 and an outer frame member 16 that are matingly engageable with each other as illustrated in FIG. 2. Inner frame member 14 and outer frame member 16 are both substantially straight, elongated members that have a length “L” and a width “W”. Preferably, inner and outer frame members 14, 16 are manufactured from a substantially rigid plastic or fiberglass and are substantially non-flexing.

Inner member 14 is generally U-shaped in cross-section and includes a bottom wall 18 with two side walls 20, 22 extend upwardly and outwardly therefrom and defining a channel 24 thereinbetween. Side wall 20 has a first surface 20a that is disposed at an angle other than 90° relative to bottom wall 18. Side wall 20 further includes a second surface 20b disposed substantially parallel to bottom wall 18. A beveled surface 20c connects first and second surfaces 20a, 20b. A region of side wall 20 extends inwardly for a distance over bottom wall 18 thereby forming a lip 26 that is separated from bottom wall 18 by a groove 28 that is in communication with channel 24. Side wall 22 has a first surface 22a that is disposed substantially at right angles to bottom wall 18, and a second surface 22b disposed substantially parallel to bottom wall 18 and at right angles to first surface 22a. A region of side wall 22 extends inwardly for a distance over bottom wall 18 thereby forming a lip 30 that is separated from bottom wall 18 by a groove 34 that is in communication with channel 24. Lip 26 and lip 30 extend toward each other and are separated by a gap that has a width “W1”. It should be noted that lips 26 and 30 each have a beveled surface 26a, 30a that enables it to be easier to insert portions of the outer frame member 16 through this gap and into channel 24.

Outer frame member 16 comprises a generally L-shaped member that interlocking engages with inner frame member 14. The L-shaped member includes a back 36 having an inner surface 36a and an outer surface 36b. A first flange 38 projects outwardly away from back 36 at an angle substantially around 90° relative to outer surface 36b. First flange 38 runs substantially the entire length “L” of back 36. When outer frame member 16 is interlocking engaged with inner frame member 14, flange 38 extends for almost the entire depth of side wall 22 from second surface 22b to bottom wall 18 of inner frame member 14. Flange 38 includes an outer surface 38a, an inner surface 38b and a tip 38c. The transition from inner surface 38b to tip 38c preferably is gently rounded. Inner surface 38b is disposed generally at right angles to outer surface 36b of back 36. Outer surface 38a preferably is disposed at an angle other than 90° to outer surface 36b.

A second flange 40 extends outwardly from back 36 and runs for substantially the entire length “L” thereof. Second flange 40 includes an outer surface 40a and an inner surface 40b that are substantially parallel to each other and are connected together by a tip 40c. Each of the inner and outer surfaces 40b, 40a is disposed at an angle other than 90° relative to outer surface 36b of back 36. Preferably, first and second flanges 38, 40 flare away from each other. Second flange 40 does not extend outwardly from back 36 for as great a distance as does first flange 38. Consequently, tip 40c of second flange 40 is disposed closer to outer surface 36b than is tip 38c of first flange 38.

Outer frame member 16 further includes a pair of legs 42, 44 disposed between first and second flanges 38, 40. Legs 42 and 44 are spaced a distance laterally apart from each other and preferably extend longitudinally from one end of outer frame member to the other. It will, of course, be understood, that a plurality of individual leg members could instead be provided at intervals along the length of outer frame member 16.

In accordance with the present invention, leg 42 has an inner surface 42a and an outer surface 42b and includes a lip 42c that extends outwardly from outer surface 42b. Leg 44 has an inner surface 44a, an outer surface 44b and includes a lip 44c that extends outwardly from outer surface 44b. Lips 42c and 44c are generally coplanar and extend in opposite directions from each other. Each of lips 42c and 44c are of a size that is sufficiently small enough to permit them to be received into one of grooves 28 and 34 of inner frame member 14.

The inner surface 36a of outer frame member 16 is not a substantially flat surface. Instead, inner surface 36a includes notches and recessed areas 48. Each notch 46 is adjacent the outer surface of one of the legs 42, 44 and recessed areas 48 are defined between legs 42, 44 and spaced a distance from each other. Notches 46 allow legs 42, 44 to flex to a certain degree when outer frame member 16 is engaged with inner frame member 14 as will be hereinafter described.

FIG. 2 illustrates how the inner frame member 14 and outer frame member 16 are interlockingly engageable with each other. It should be noted that the angle of inner surface 40b of second flange 40 and beveled surface 20c on side wall 20 are substantially identical. When inner and outer frame members 14, 16 are engaged, inner surface 40b and beveled surface 20c are disposed adjacent each other and are oriented substantially parallel to each other. Furthermore, side wall 20, including lip 26 is sized to be received between second flange 40 and leg 42 and side wall 22 is sized to be received between first flange 38 and leg 44. Lips 42c and 44c on legs 42, 44 are received in grooves 28 and 34 respectively, thereby interlocking engaging inner and outer frame member 14, 16 together in such a manner that they cannot be accidentally separated from each other. Inner frame member 14 and outer frame member 16 are snap fitted together and are retained in place by friction.

It should be noted, however, that while inner and outer frame members 14, 16 are interlocking engaged, the fit between inner and outer frame members 14, 16 is fairly loose. By this it is meant that there is some vertical play between inner and outer frame members 14, 16 as is indicated by arrow A-A1 in FIG. 2. There is also some horizontal play between inner and outer frame members 14, 16 as is indicated by arrow B-B1 in FIG. 2. This loose fit between inner and outer frame members 14, 16 causes a gap 52 to be formed between the inner and outer frame members 14, 16 when they are engaged and it is into this gap 52 that the vinyl pool liner 54 is received as will be hereinafter described.

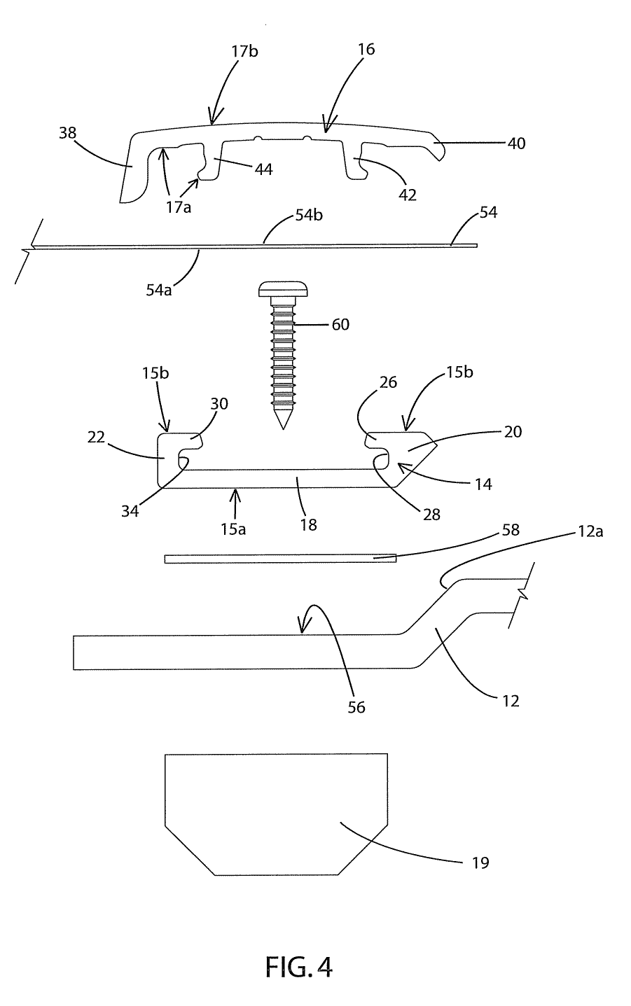

FIGS. 3-7 show the sealing member 10 in accordance with the present invention being used to secure vinyl pool liner 54 to a stair system 12. In this instance, stair system 12 defines a recessed area 56 sized and shaped to received inner frame member 14 therein. A backer board 19 is received on a back surface of stair system 12 proximate the region where inner frame member 14 will be engaged. As shown in FIG. 4, the wall that defines recessed area 56 preferably includes a surface 12a that is complementary in shape and angle to first surface 20a of inner frame member 14. This enables the installer to quickly and easily orient the outer frame member 16 for interlocking engagement with inner frame member 14. If outer frame member 16 is oriented incorrectly for engagement with inner frame member 14, the second flange 40 on outer frame member 40 will contact surface 12a and essentially prevent outer frame member 16 from being pushed into channel 24 in inner frame member 14. This ensures that all components are oriented correctly so that the best seal possible is obtained between sealing member 10 and pool liner 54.

As shown in FIG. 4, inner frame member 14 has an interior surface 15a adapted to abut gasket 58 and an exterior surface adapted to abut an interior surface 54a of liner 54. Outer frame member 16 has an interior surface 17a and an exterior surface 17b. Interior surface 17a is adapted to abut an exterior surface 54b of liner 54.

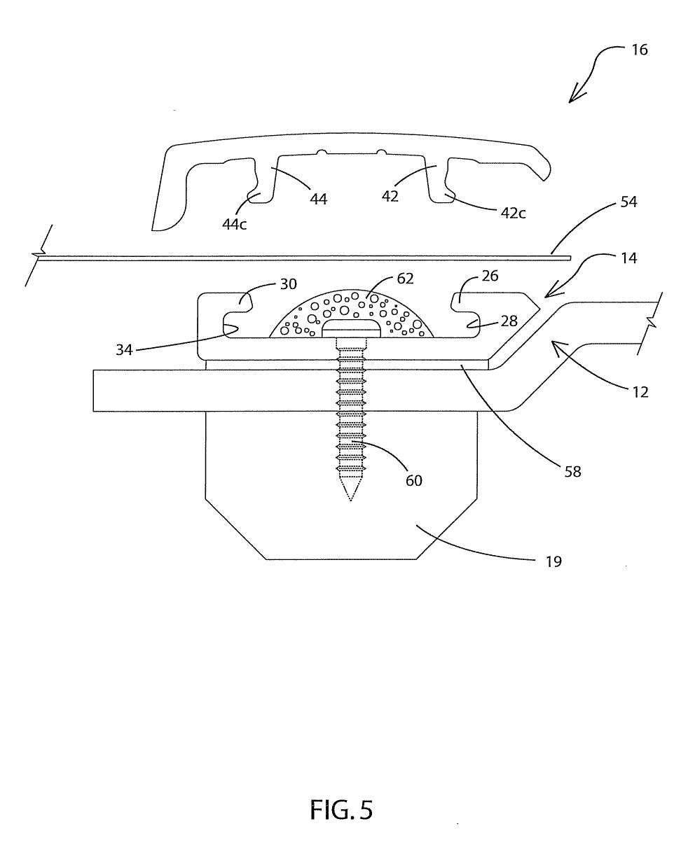

The installer positions a backer board 19 adjacent a rear surface of stair system 12. A gasket 58 is then positioned between interior surface 15a of inner frame member 14 and the recessed area 56 on stair system 12. A plurality of fasteners 60 are used at spaced at intervals along the length of inner frame member 14 to secure inner frame member 14 to stair system 12 and backer board 19. It will be understood that instead of fasteners 60, inner frame member 14 may be glued into recessed area 56 or inner frame member 14 and gasket 58 may be glued to each other and into recessed area 56. FIG. 5 shows that a bead of caulking 62 or other type of sealant is introduced into channel 24 of inner frame member 14. The bead of caulking 62 preferably extends longitudinally for the entire length of inner frame member 14. The installer then installs the liner as has been described in the background section of this application. Essentially, the interior surface 54a of the liner 54 is placed in abutting contact with the pool walls and floor. When the installer reaches the region of the pool in which stair system 12 is located, the interior surface 54a of liner 54 is positioned over the exterior surface 15b of the previously installed inner frame member 14. For the sake of clarity, only the small portion of liner 54 that overlays inner frame member 14 is shown in FIG. 3. It will be understood, however, that liner 54 extends across the entire access opening to stair system 12 and around the entire perimeter of the pool.

Once the air has been evacuated from between the interior surface 54a of liner 54 and the pool walls and floor, the installer engages the outer frame member 16 with inner frame member 14. This is accomplished by contacting the exterior surface 54b of liner 54 with the interior surface 17a of outer frame member 16. Most specifically, the legs 42, 44 of outer frame member 16 are placed in contact with the exterior surface 54b of liner 54 and the installer pushes the outer frame member 16 inwardly toward inner frame member 14. This movement causes legs 42, 44 of outer frame member 16 to enter into channel 24 of inner frame member 14. As legs 42, 44 move into channel 24, they force a portion of liner 54 into channel 24 and into contact with the bead of caulking 62. The installer pushes outer frame member 16 inwardly toward inner frame member 14 until tips 42c, 44c of legs 42, 44 enter grooves 28, 34. The inwardly moving legs 42, 44 and liner 54 forces caulking 62 to spread throughout channel 24 and into grooves 28, 34. The caulking is trapped between liner 54 and inner frame member 14, thus sealing off fluid access to an interior surface of liner 54. Consequently, neither air nor water can cross the barrier formed by sealing member 10 with liner 54. Furthermore, liner 54 is tightly retained in the gap 52 between inner and outer frame members 14, 16. Thus, the outer frame member rigidly maintains the pool liner in the channel 24 and in contact with the caulking 62. The inner and outer frame members retain the pool liner therebetween in such a manner that the liner is not pierced.

After the installer has secured liner 54 along the sides 12a, 12b and the bottom 12c of stair system 12, he takes a cutting tool and cuts away that portion of the liner that spans the opening between sides 12a, 12b.

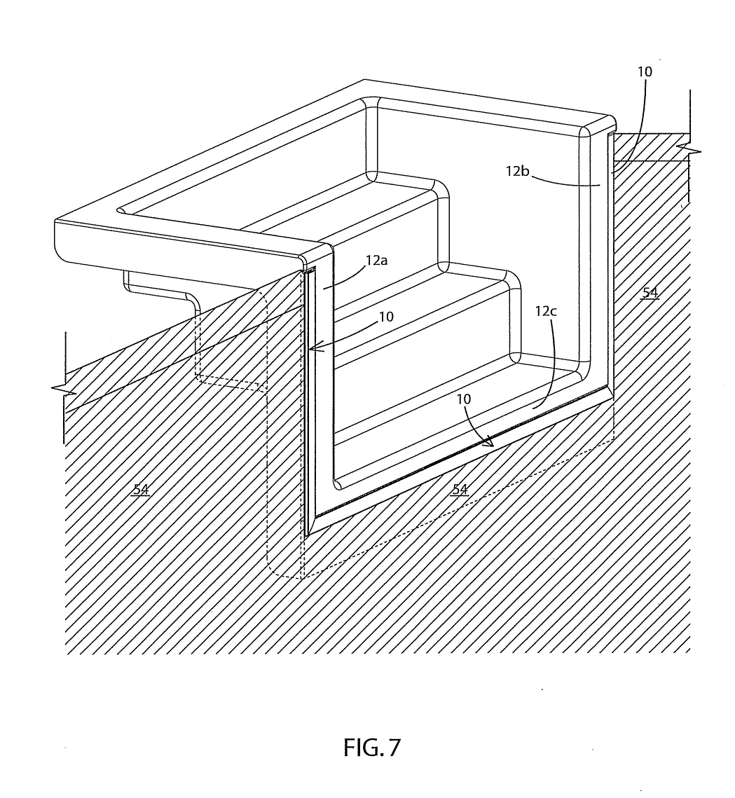

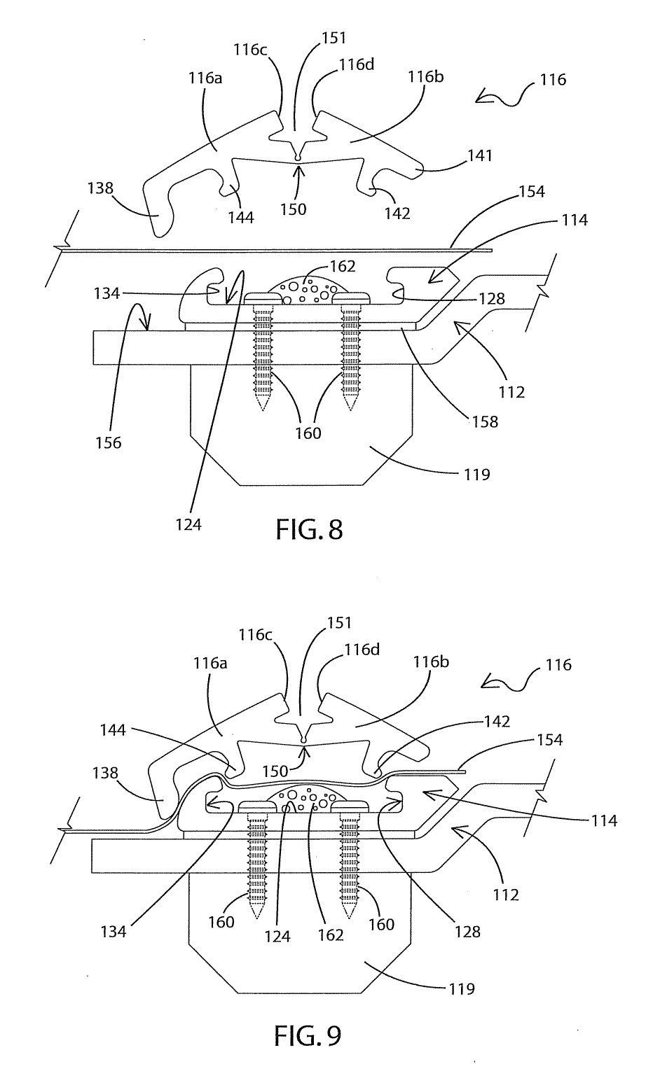

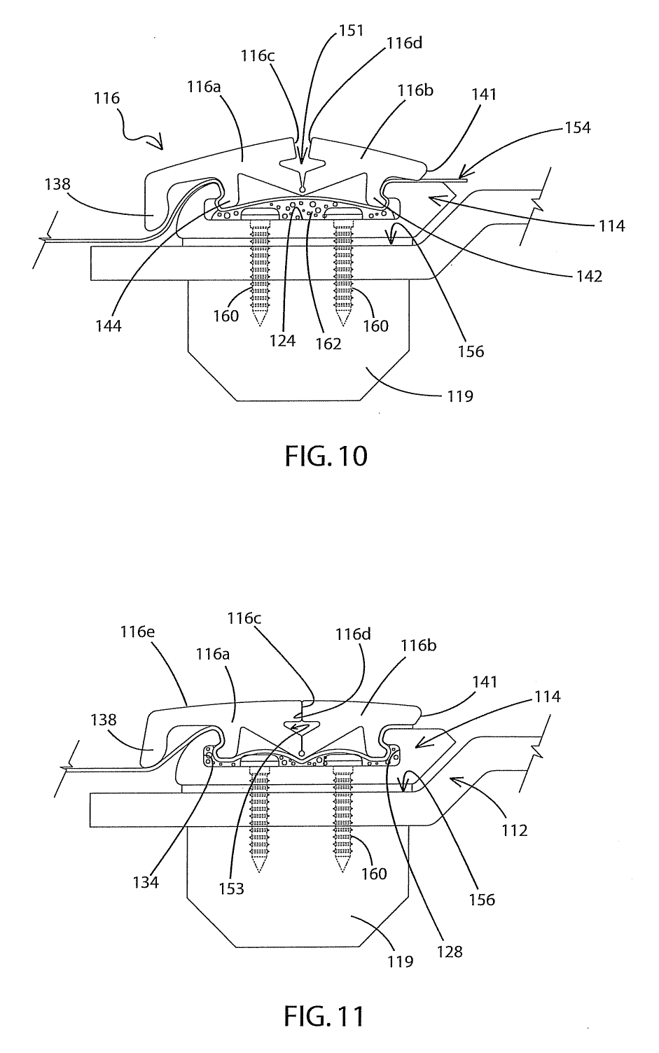

Referring to FIGS. 8-11, there is shown a second embodiment of a sealing member in accordance with the present invention and generally indicated at 110. All of the various components of the sealing member 110 are substantially identical to the components of sealing member 10 with the exception of the outer frame member 116. Consequently, sealing member 110 includes an inner frame member 114 that is secured by screws 160 into a recess 156 to a fixture, such as a stair system 112, and to a backer board 119 associated therewith. In the first embodiment of the invention, a single screw 60 was disposed within channel 24. In this present embodiment, a pair of spaced apart screws is disposed a spaced distance laterally from each other across the width of channel 124. A gasket 158 is disposed between inner frame member 114 and stair system 112. A bead of sealant material, or caulking, 162 is placed in the channel 124 of inner frame member 114 and preferably between screws 160.

As indicated above, outer frame member 116 differs from outer frame member 16 in that it includes a living hinge 150 disposed in the region between legs 142 and 144, and does not include a second flange equivalent to flange 40 on outer frame member 16. Living hinge 150 is a narrower region that divides outer frame member 116 into two sections 116a and 116b which are movable relative to each other about hinge 150. Section 116a has an inner edge 116c that is opposed to an inner edge 116d of section 116b. Section 116b has a rounded tip 141 instead of the second flange 40 of outer frame member 16. The installer is able to flex outer frame member 116 about living hinge 150 during installation of liner 154. This can be accomplished by holding outer frame member 116 between the thumb and forefinger of one hand and pushing inwardly. This movement opens a gap 151 between inner edges 116c, 116d and slightly reduces the distance between legs 142, 144. It is therefore easier to ease legs 142, 144 of outer frame member 116 into channel 124 of inner frame member 114. As legs 142, 144 slide into channel 124, they engage liner 154 and push the same inwardly into channel 124. This movement causes the bead of caulking 162 to spread out in channel 124 and into grooves 128, 134 thereby bonding liner 154 to inner frame member 114. Tips 142c, 144c of legs 142, 144 slide into grooves 128, 134 and, as they do so, the gap 151 between inner edges 116c, 116d narrows until the outer surfaces of sections 116a and 116b are flush (FIG. 11). The outermost surface of sections 116a and 116b are represented in FIG. 11 as outer surface 116e. At this stage, outer frame member 116 is interlockingly engaged with inner frame member 114 and liner 154 is clamped, wedged or retained thereinbetween. Outer frame member 116 will tend to stay in the closed position as hinge 150 is positioned below the longitudinal center of outer frame member 116 and when closed will move sections 116a and 116b to the over-center position. A hollow passageway 153 is created by the closure of gap 151. If it is necessary at some point to disengage outer frame member 116 from inner frame member 114, the installer may insert the head of a flathead screwdriver between the abutting inner edges 116c, 116d and into the passageway 153. The screwdriver can then be used as a lever to separate section 116a from section 116b.

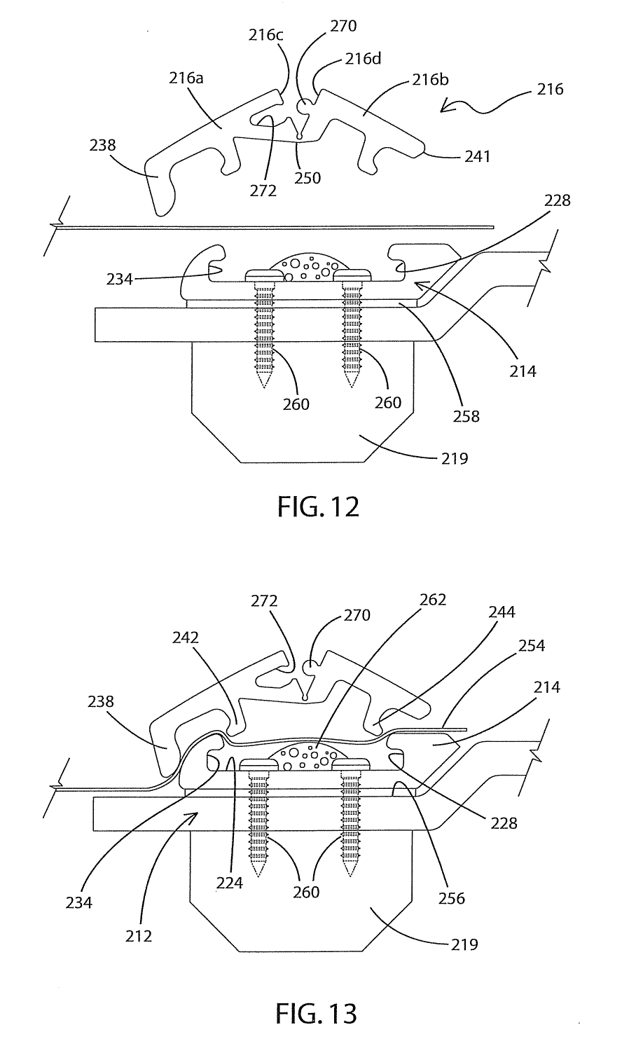

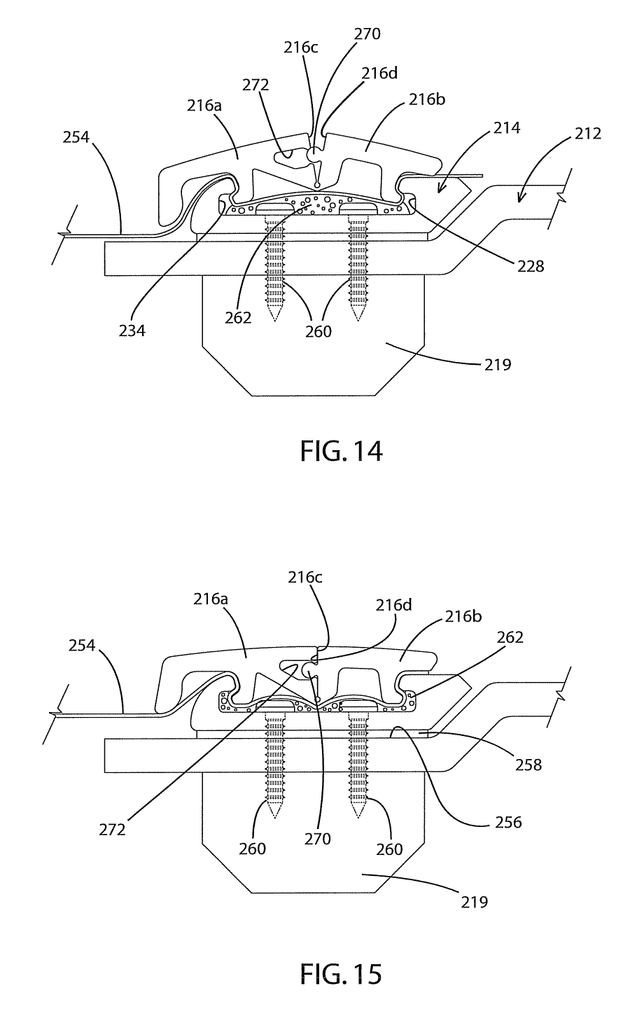

FIGS. 12-15 show a variation of outer frame member 116, with the variation being generally indicated in these figures by the number 216. Outer frame member 216 is substantially identical to outer frame member 116 except that the inner edges 216c, 216d of sections 216a, 216b are provided with a locking mechanism. The locking mechanism comprises a latch member 270 that projects outwardly from the inner edge of one of sections 216a, 216b and a corresponding aperture 272 defined in the inner edge of the other of sections 216a, 216b. In the attached illustrations, latch member 270 extends outwardly from inner edge 216d of section 216b and the corresponding, complementary aperture 272 is defined in the inner edge 216c of section 216a.

As with the previous embodiments, inner frame member 214 is secured to stair system 212 and backer board 219, or some other fixture, by a plurality of screws 260. As with the previous version, pairs of screws 260 are utilized for this purpose at spaced intervals along the length of inner frame member 214. A gasket 258 is positioned between inner frame member 214 and recessed region 260 of stair system 212. Outer frame member 216 is used to force liner 258 into channel 224 of inner frame member 214 in much the same manner as in the previous embodiment. However, as outer frame member 216 is pushed inwardly to move legs 242, 244 and therefore the liner 258 into channel 214, the latch member 270 progressively enters the corresponding aperture 272 (FIGS. 12-14) until latch member 270 is entirely retained within aperture 272 (FIG. 15). At this point, sections 216a and 216b are latched together and cannot be accidentally dislodged. As with the previous version, sections 216a, 216b may be separated from each other by inserting the head of a flat head screwdriver between inner edges 216c and 216d and then using the screwdriver as a lever to separate sections 216a and 216b. The insertion of legs 242 and 242 forces liner 254 into channel 224 of inner frame member 214 and into contact with sealant 260. The sealant 260 spreads throughout channel 260 and into grooves 228, 234.

It will be understood that while the inner frame member has been disclosed as having an interior channel therein and the outer frame member has been disclosed as having a pair of spaced apart legs that are receivable within the channel, the legs may instead be provided on the inner frame member and the channel defined in the outer frame member without departing from the spirit of the present invention.

It should further be understood that the bead of sealant or caulking that is placed in the channel in the inner frame member may be placed there by the manufacturer or may be placed there by an installer.

Furthermore, the embodiments of the invention illustrated in FIGS. 8-15 are shown as incorporating a living hinge 150 formed by molding a thinner region of plastic material than the remainder of the outer frame member. It should be understood that the outer frame member may, instead, be provided with an actual hinge that is mounted between the two sections 116a and 116b or 216a and 216b.

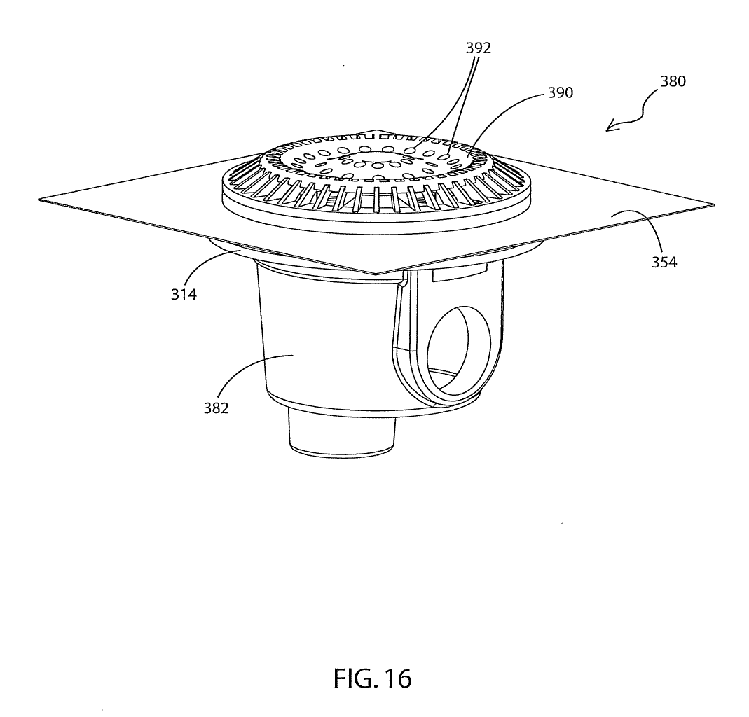

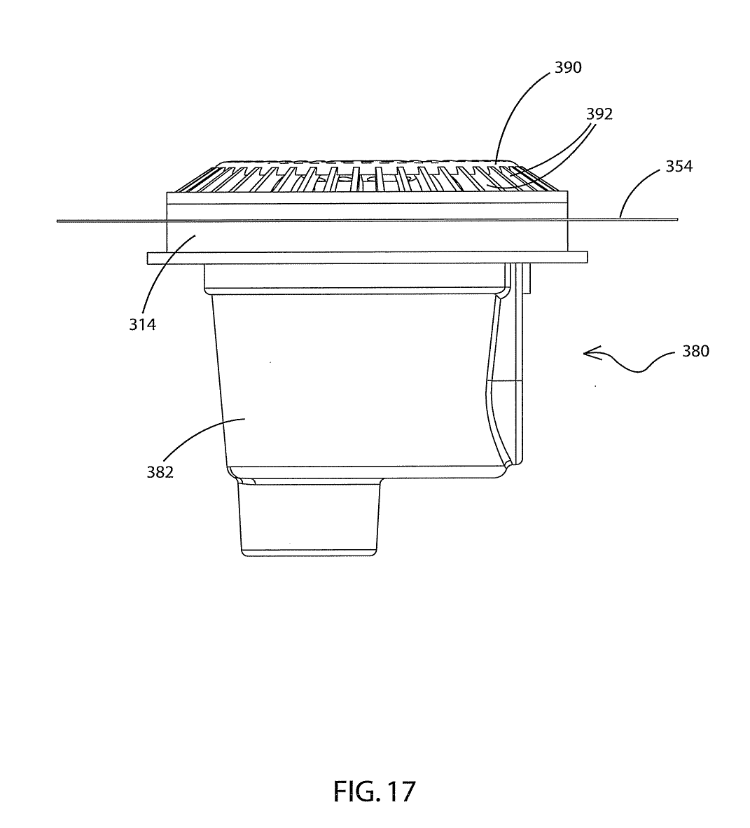

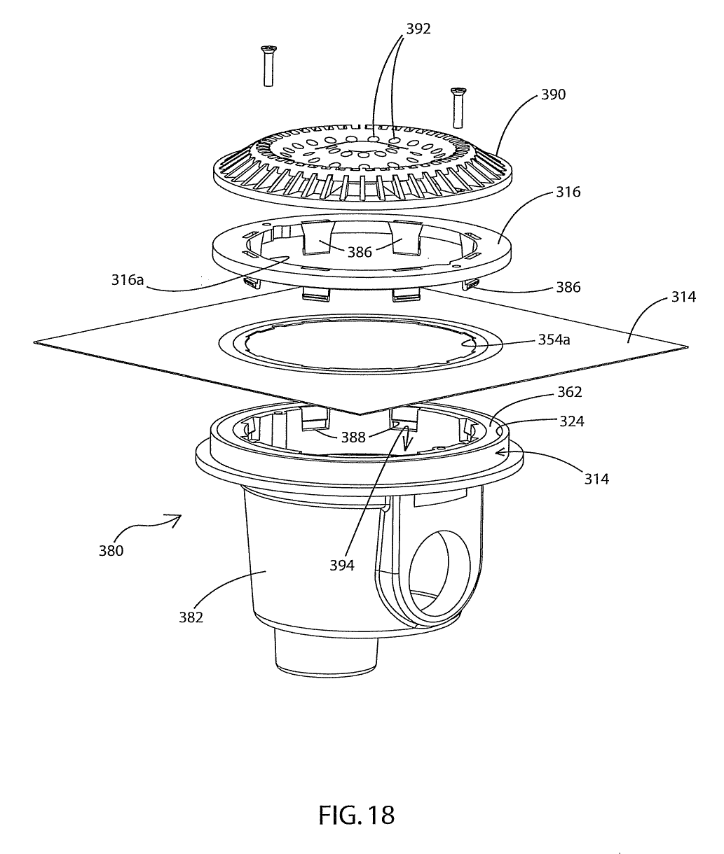

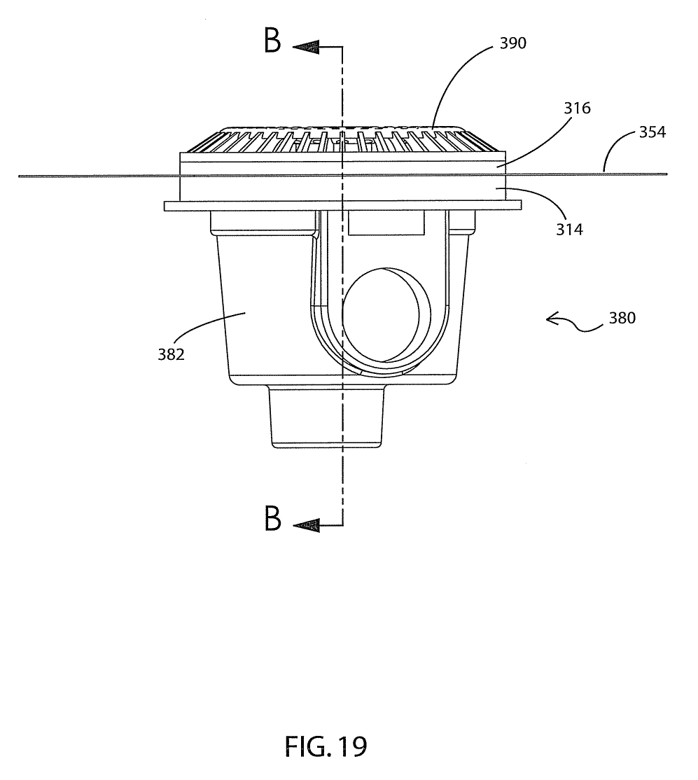

Referring to FIGS. 16-21 there is shown a third embodiment of a sealing member in accordance with the present invention and generally indicated at 310. The fixtures that are typically installed in pools using vinyl liners are made from plastic or fiberglass. As such, they are molded or cast from the plastic or fiberglass. In accordance with the present invention, sealing member 310 is molded or cast into smaller fixtures such as the drain 380 illustrated in these figures. In these instances, instead of utilizing an inner frame member and outer frame member that are designed to snap fit together, an outer portion of the frame of the fixture itself is designed to snap-fit with an inner portion of the frame. The liner is trapped therebetween in much the same way as was described with reference to the embodiments shown in FIGS. 1-15.

Drain 380 is therefore provided with a housing 382 molded to include an inner frame member 314. Inner frame member 314 is molded to include an annular channel 324 therein. An annular outer frame 316 is provided to snap-fittingly engage inner frame 314 and to retain a portion of liner 354 thereinbetween.

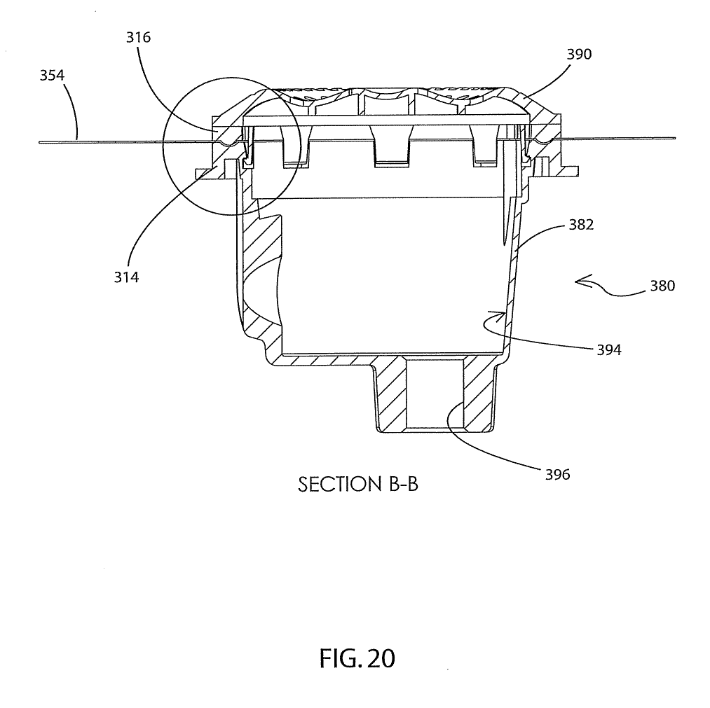

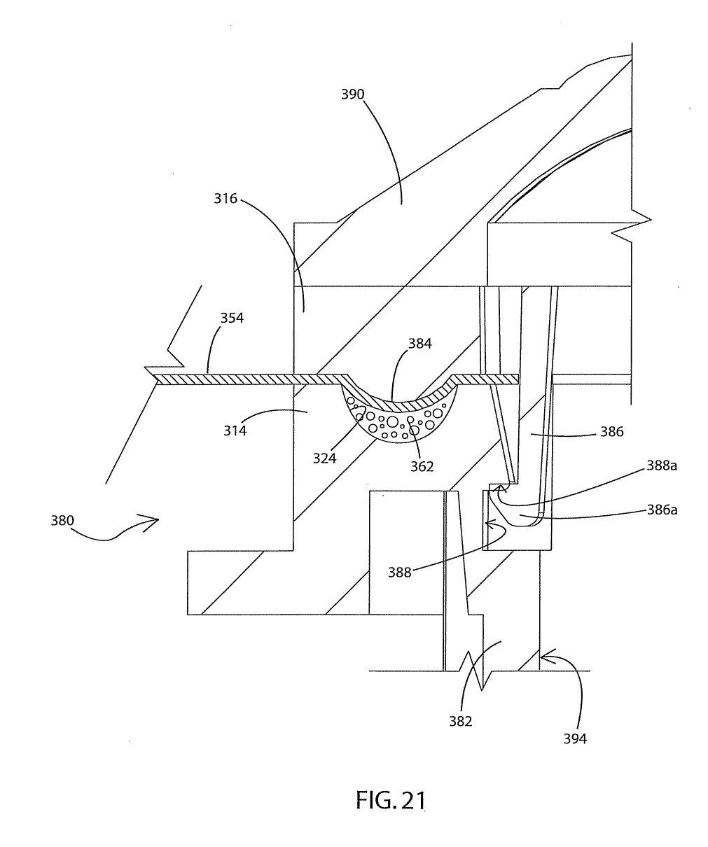

FIG. 21 shows outer frame member 316 including an annular ridge 382 positioned to be received in channel 324 of inner frame member 314. Ridge 384 preferably is of a shallower arc of curvature than is channel 324. A bead of caulking or other sealant 362 is placed in channel 324 either during manufacture or by the installer during installation of the fixture Outer frame member 316 preferably includes a plurality of leg members 386 configured to lockingly engage in the complementary shaped and positioned recessed regions 388 on inner frame member 314. A cover 390 is mounted over outer frame member 316. Cover 390 is provided with a plurality of apertures 392 therein to allow water from the pool to flow into the interior 394 of housing 382 and subsequently out of the outlet 396 (FIG. 20) therein.

The drain 380 will be installed in an appropriate location in the pool prior to the installation of liner 354. Specifically, housing 380 is installed and is connected to a drainage system (not shown) via outlet 396. If necessary, the installer will apply the bead of caulking 362 into channel 324 of lower frame member 314. The liner is then installed in the pool and will be drawn tightly across the opening to the interior 394 of housing 382. After the air has been evacuated from between liner 354 and the surface of the pool that it abuts, the installer will engage outer frame member 316 with inner frame member 314. This is accomplished by positioning outer frame member 316 over inner frame member 314 in such a manner that a portion of ridge 384 is received in channel 324 in inner frame member 314. As the ridge 384 enters channel 324 it forces a portion of liner 354 into caulking 362. The caulking 362 is spread throughout the entire channel 324 and the liner 354 becomes sealingly retained between inner and outer frame members 314, 316. When leg members 386 reach the appropriate locations, the tip 386a of each leg member 386 slides under a complementary shoulder 388a in recessed areas 388 on inner frame member 314, thereby locking the frame members 314, 316 together.

The installer then uses a cutting tool to cut away the region of liner 354 that extends across the opening 316a of outer frame member 316. Liner 354 is thereby provided with an opening 354a through which water may flow. Cover 390 is then screwed into position over outer frame member 316.

The provision of this type of sealing member, comprised of an inner frame member molded to one part of a small fixture and an outer frame member molded to another part of the small fixture, may be utilized on any of the smaller fixtures or components that need to be sealingly mounted on a vinyl pool liner.

It will be understood that while FIGS. 3 and 7 show an inner frame member that is mechanically attachable to a stair system by way of a plurality of fasteners, the inner frame member may, instead, be integrally molded with the stair system in much the same manner as is disclosed with reference to the molding of the inner frame member 314 on the drain fixture illustrated in FIGS. 16-21.

None of the embodiments of the invention disclosed herein requires any type of elongated fastener, such as a screw, that will pierce the liner when it is being secured to the fixture. Instead, two complementary frame members are used to retain the liner between them in a manner that does not cause the liner to be pierced. The bead of caulking or sealant ensures that there is an air-tight and water-tight seal between these components.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A sealing member for sealing a pool fixture to a vinyl pool liner comprising:
an inner frame member adapted to be disposed in abutting contact with an interior surface of the pool liner;
an outer frame member adapted to be disposed in abutting contact with an exterior surface of the pool liner; said outer frame member being interlockingly engageable with the inner frame member, whereby a portion of the pool liner is retained thereinbetween.

2. The sealing member as defined in claim 1, wherein one of the inner and outer frame members includes a boss and the other of the inner and outer frame members defines a recess therein and the boss and recess are complementary, and wherein the portion of the pool liner is retained in the recess by the boss.

3. The sealing member as defined in claim 2, further comprising a bead of sealing material provided one of in the recess and on the boss, and when the inner and outer frame members are engaged, the portion of the pool liner is retained within the recess by the boss and is maintained in contact with the sealing material.

4. The sealing member as defined in claim 2, wherein each of the inner and outer frame members includes a pool-liner-engaging surface, and the recess defined in the pool-liner-engaging surface of one of the inner and outer frame members is an elongated channel.

5. The sealing member as defined in claim 4, wherein the boss extends outwardly away from the pool-liner-engaging surface of the other of the inner and outer frame members, and comprises at least one elongated projection that is receivable in the channel.

6. The sealing member as defined in claim 4, wherein the boss extends outwardly away from the pool-liner engaging surface of the other of the inner and outer frame members and comprises two spaced-apart projections that are receivable in the channel.

7. The sealing member as defined in claim 5, further comprising:
a lip that extends outwardly from the projection; and
a groove defined in the pool-engaging surface of the one of the inner and outer frame members defining the channel, said groove being in communication with the channel, and wherein the lip is received in the groove when the projection is engaged in the channel thereby interlockingly engaging the inner and outer frame members together.

8. The sealing member as defined in claim 5, wherein a hook member extends outwardly from the pool-liner engaging surface of one of the inner and outer frame members a spaced distance from the projection, and a groove is defined in the pool-liner engaging surface of the other of the inner and outer frame members a spaced distance from the channel and the hook member is receivable in the groove thereby interlockingly engaging the inner and outer frame members together.

9. The sealing member as defined in claim 5, wherein the one of the inner and outer frame members that includes the projection further includes a hinge that enables the one of the inner and outer frame members to flex for insertion of the projection into the channel of the other of the inner and outer frame members.

10. The sealing member as defined in claim 9, wherein the one of the inner and outer frame members includes a first section and a second section that are connected together by the hinge, and the first section has a first inner edge and the second section has a second inner edge, and the first and second inner edges are movable between a first position when they abut each other to a second position where they are remote from each other.

11. The sealing member as defined in claim 10, wherein one of the first and second inner edges includes a latching member, and the other of the first and second inner edges includes a complementary latching aperture.

12. The sealing member as defined in claim 1, wherein the inner and outer frame members are securable to each other without the use of fasteners that will pierce the liner.

13. The sealing member as defined in claim 1, wherein the inner frame member comprises a portion of the fixture to be sealingly secured to the pool liner.

14. In combination:
a pool fixture;
a vinyl pool liner
a sealing member comprising:
an inner frame member mountable on the pool fixture and having an exterior surface disposed to abut an interior surface of the pool liner;
an outer frame member having an interior surface and an exterior surface; wherein the outer frame member is interlockingly engageable with the inner frame member; whereby a portion of the pool liner is retained between the interior surface of the outer frame member and the exterior surface of the inner frame member.

15. The combination as defined in claim 14, wherein one of the inner and outer frame member defines a channel therein and the other of the inner and outer frame members has at least one projection extending outwardly away therefrom; and wherein the projection is receivable in the channel, whereby the portion of the pool liner is retained in the channel by the at least one projection.

16. The combination as defined in claim 15, further comprising a bead of sealing material disposed one of in the channel and on the at least one projection, whereby the at least one projection forces the portion of the pool liner into contact with the sealing material.

17. The combination as defined in claim 16, further comprising a gasket mountable on the pool fixture between the inner frame member and an external surface of the pool fixture.

18. The combination as defined in claim 15, wherein the inner frame member is formed as part of the pool fixture and the outer frame member is selectively engageable with the inner frame member.

19. A method of sealing a pool fixture to a vinyl pool liner comprising the steps of:
providing an inner frame member having an exterior surface with one of a channel and a boss;
providing an outer frame member having an interior surface defining the other of the channel and the boss, wherein the other of the channel and the boss of the outer frame member is complementary to the one of the channel and the boss of the inner frame member;
mounting the inner frame member on the pool fixture;
applying a pool liner over the pool fixture and the inner frame member, whereby the exterior surface of the inner frame member is in contact with a portion of an interior surface of the pool liner;
contacting an exterior surface of the pool liner with the outer frame member;
engaging the outer frame member with the inner frame member such that the boss of the one of the inner and outer frame members is received in the channel of the other of the inner and outer frame members, whereby a portion of the pool liner is retained between the inner and outer frame members.

20. The method as defined in claim 19, including the step of applying a bead of sealing material one of into the channel and onto the projection prior to engaging the inner and outer frame members.

21. The method as defined in claim 19, wherein the steps of providing the inner and outer frame members includes providing the inner frame member defining the channel therein and the outer frame member having the projection extending outwardly therefrom; and the method further includes the step of flexing the outer frame member about a living hinge prior to inserting the projection into the channel.
